(19) United States
(12) Patent Application Publication
(10) Pub. No.: US 2022/0343106 A1
(43) Pub. Date: Oct. 27, 2022

(54) ELECTRONIC DEVICE FOR PROCESSING DATA BASED ON ARTIFICIAL INTELLIGENCE MODEL AND METHOD FOR OPERATING THE SAME

(71) Applicant: Samsung Electronics Co., Ltd., Gyeonggi-do (KR)

(72) Inventors: Jongbum CHOI, Gyeonggi-do (KR); Youngjo KIM, Gyeonggi-do (KR); Hyunhee PARK, Gyeonggi-do (KR); Hyungju CHUN, Gyeonggi-do (KR); Changsu HAN, Gyeonggi-do (KR); Jonghun WON, Gyeonggi-do (KR); Jaemyung LEE, Gyeonggi-do (KR)

(21) Appl. No.: 17/708,585

(22) Filed: Mar. 30, 2022

Related U.S. Application Data
(63) Continuation of application No. PCT/KR2021/019673, filed on Dec. 23, 2021.

(30) Foreign Application Priority Data
Apr. 27, 2021 (KR) 10-2021-0054493

(51) Int. Cl. G06K 9/62; G06N 3/04

(52) U.S. Cl. CPC G06K 9/623; G06N 3/0454; G06N 3/0481

(57) ABSTRACT

According to various embodiments, there may be provided a method for operating an electronic device, including executing, by at least one processor of the electronic device, an application and obtaining at least one content based on the executed application, selecting first values from among a plurality of values associated with an computation capability to process the obtained at least one content, and obtaining first result data by processing the at least one content, using a first artificial intelligence model having at least one first parameter, obtained by configuring at least one parameter of an artificial intelligence model stored in the electronic device as the at least one first parameter corresponding to the first values, selecting second values from among the plurality of values based on an occurrence of a specific event, and obtaining second result data by processing the at least one content, using a second artificial intelligence model having at least one second parameter, obtained by configuring the at least one parameter of the artificial intelligence model as the at least one second parameter corresponding to the second values.

### CROSS-REFERENCE TO RELATED APPLICATIONS

This application is a continuation of International Application No. PCT/KR2021/019673 designating the United States, filed on Dec. 23, 2021, in the Korean Intellectual Property Receiving Office and claiming priority to Korean Patent Application No. 10-2021-0054493, filed on Apr. 27, 2021, in the Korean Intellectual Property Office, the disclosures of which are incorporated by reference herein in their entireties.

### BACKGROUND

### Field

The disclosure relates to an electronic device for processing data based on an artificial intelligence model and a method for operating the same.

### Description of Related Art

Portable digital communication devices have become a must-have item for everyone in modern era. Customers desire to receive various high-quality services anytime, anywhere using their portable digital communication devices.

Recently, artificial intelligence models trained based on an artificial intelligence training algorithm are stored in portable digital communication devices, and various types of data obtained using artificial intelligence models trained by the portable digital communication devices are processed to provide various high-quality services.

However, since large resources are required to operate artificial intelligence models, there is increasing demand for technology for optimizing artificial intelligence models to operate the artificial intelligence models on portable digital communication devices.

An electronic device may store a plurality of pre-trained artificial intelligence (AI) models (e.g., deep learning models or machine learning models) and process data (e.g., image data or audio data), obtained based on a plurality of artificial intelligence models, to thereby obtain result data (e.g., instance segmented image data). The pre-trained artificial intelligence models are implemented using at least one parameter (e.g., a weight and/or activation function) obtained according to AI-training to process input data, and at least one parameter thereof may be set to high-complexity computation values to precisely process data. Thus, upon using pre-trained AI models, the electronic device may perform computation based on at least one parameter set to high-complexity computations, which may overburden the electronic device. Further, regardless of the computation values of at least one parameter (e.g., the weight and/or activation function) of the AI models according to the characteristics of data, in some cases there may be no difference or minute difference between the result data obtained using each of the AI model including different parameters. In this case, if the electronic device uses a pre-trained AI model including parameters set to high-complexity computation values, the computation load of the electronic device may be relatively increased.

According to various embodiments, an electronic device and method for operating the same may mitigate computation loads of the electronic device by dynamically configuring at least one parameter (e.g., weight or activation function) of pre-trained artificial intelligence models as at least one parameter with low computation values. According to various embodiments, an electronic device and method for operating the same may dynamically configure at least one parameter (e.g., weight or activation function) of pre-trained artificial intelligence models as at least one parameter with low-computation values, based on the characteristics of differences between resultant data according to the characteristics of input data (e.g., no or little difference between result data regardless of the computation values of at least one parameter (e.g., weight or activation function), thereby mitigating computation burdens of the electronic device while obtaining high-accuracy result data.

### SUMMARY

According to various embodiments, there may be provided a method for operating an electronic device, including executing, by at least one processor of the electronic device, an application and obtaining at least one content based on the executed application, selecting first values from among a plurality of values associated with a computation capability to process the obtained at least one content, and obtaining first result data by processing the at least one content, using a first artificial intelligence model having at least one first parameter, obtained by configuring at least one parameter of an artificial intelligence model stored in the electronic device as the at least one first parameter corresponding to the first values, selecting second values from among the plurality of values based on an occurrence of a specific event, and obtaining second result data by processing the at least one content, using a second artificial intelligence model having at least one second parameter, obtained by configuring the at least one parameter of the artificial intelligence model as the at least one second parameter corresponding to the second values.

According to various embodiments, there may be provided an electronic device, including at least one processor configured to execute an application and obtaining at least one content based on the executed application, select first values from among a plurality of values associated with a computation capability to process the obtained at least one content, obtain first result data by processing the at least one content, using a first artificial intelligence model having at least one first parameter, obtained by configuring at least one parameter of an artificial intelligence model stored in the electronic device as the at least one first parameter corresponding to the first values, select second values from among the plurality of values based on an occurrence of a specific event, and obtain second result data by processing the at least one content, using a second artificial intelligence model having at least one second parameter, obtained by configuring the at least one parameter of the artificial intelligence model as the at least one second parameter corresponding to the second values.

According to various embodiments, there may be provided a method for operating an electronic device, including executing, by at least one processor of the electronic device, an application and obtaining at least one content based on the executed application, selecting a first processor to process the obtained at least one content using an artificial intelligence model stored in the electronic device, the first processor configured to correspond to first values among a plurality of values associated with computation capability, controlling the first processor to process the at least one content, using a first artificial intelligence model having at least one first parameter, obtained by configuring at least one parameter of an artificial intelligence model stored in the electronic device as the at least one first parameter corresponding to the first values, selecting a second processor based on an occurrence of a specific event, the second processor configured to correspond to second values among the plurality of values associated with the computation capability, and controlling the second processor to process the at least one content, using a second artificial intelligence model having at least one second parameter, obtained by configuring the at least one parameter of the artificial intelligence model as the at least one second parameter corresponding to the second values.

Embodiments of the disclosure are not limited to the foregoing objectives, and other objectives would readily be appreciated by a skilled artisan from the following detailed description taken in conjunction with the accompanying drawings.

According to various embodiments, there may be provided an electronic device and method for operating the same that may mitigate computational loads of the electronic device by dynamically configuring at least one parameter (e.g., weight or activation function) of a pre-trained artificial intelligence models as at least one parameter with low computation values.

According to certain embodiments, there may be provided an electronic device and method for operating the same that may dynamically configure at least one parameter (e.g., a weight or activation function) of pre-trained artificial intelligence models as at least one parameter with low-computation values, based on difference characteristics of the resultant data according to the characteristics of the input data (e.g., little or no difference between result data regardless of the computation values of at least one parameter, such as a weight or activation function), thereby mitigating computation burdens of the electronic device while obtaining high-accuracy result data.

### BRIEF DESCRIPTION OF THE DRAWINGS

FIG. 1 is a view illustrating an electronic device in a network environment according to various embodiments;

FIG. 2 is a view illustrating an example configuration of an electronic device according to various embodiments;

FIG. 3 is a view illustrating an example artificial intelligence model according to various embodiments;

FIG. 4A is a view illustrating an example of a content processing computation based on an artificial intelligence model of a processor according to various embodiments;

FIG. 4B is a view illustrating an example of an computation in which a parameter (e.g., weight) of an artificial intelligence model is obtained (or quantized) based on a computation value according to various embodiments;

FIG. 4C is a view illustrating another example of an computation in which a parameter (e.g., activation function) of an artificial intelligence model is obtained (or quantized) based on a computation value based on a computation value according to various embodiments;

FIG. 5 is a flowchart illustrating an example of an operation of an electronic device according to various embodiments;

FIG. 6 is a view illustrating an example of an operation of processing content (e.g., image data) using an artificial intelligence model by an electronic device according to various embodiments;

FIG. 7A is a view illustrating an example of an operation using an artificial intelligence model by selecting or changing computation values among a plurality of computation values by an electronic device according to various embodiments;

FIG. 7B is a view illustrating an example of an operation of using an artificial intelligence model by selecting or changing a processor among a plurality of processors by an electronic device according to various embodiments;

FIG. 8 is a flowchart illustrating an example of an operation of an electronic device according to various embodiments;

FIG. 9 is a view illustrating an example of an operation of calculating a cost for each of a plurality of computation combinations by an electronic device according to various embodiments;

FIG. 10 is a view illustrating an example of result data obtained by artificial intelligence models having at least one parameter configured based on different computation combinations according to various embodiments;

FIG. 11A is a view illustrating an example of an operation of calculating costs during a designated period by an electronic device according to various embodiments; and

FIG. 11B is a view illustrating another example of an operation of calculating costs during a designated period by an electronic device according to various embodiments.

### DETAILED DESCRIPTION

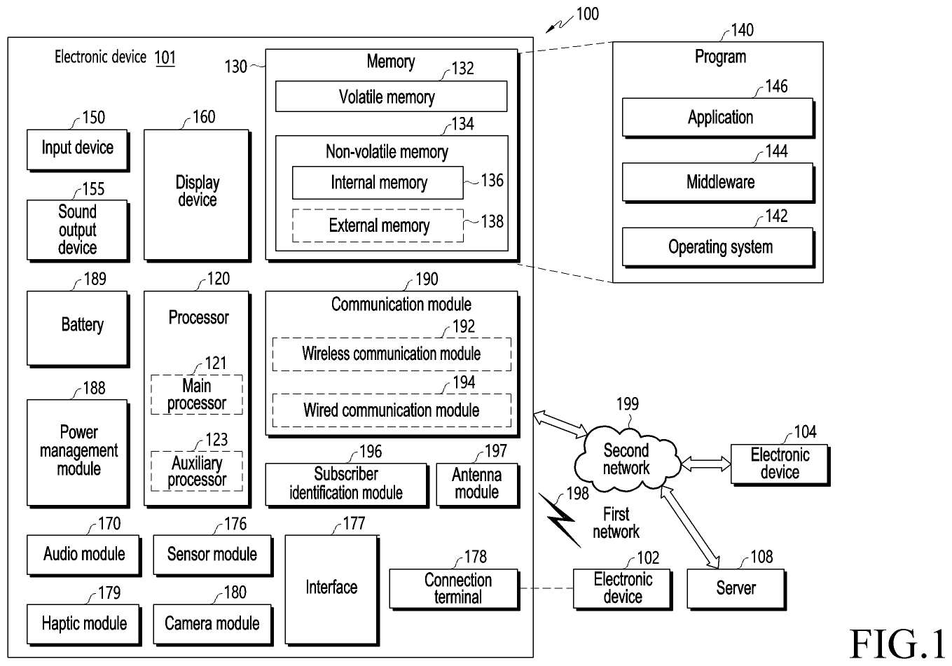

FIG. 1 is a block diagram illustrating an electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197. According to certain embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to various embodiments may be one of various types of electronic devices. The electronic devices may include, for example, a portable communication device (e.g., a smart phone), a computer device, a portable multimedia device, a portable medical device, a camera, an electronic device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Hereinafter, examples of a configuration of the above-described electronic device 101 according to various embodiments is described.

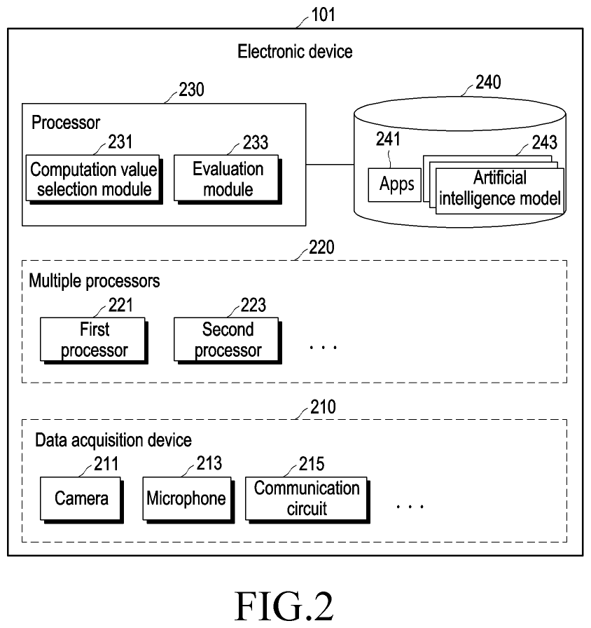

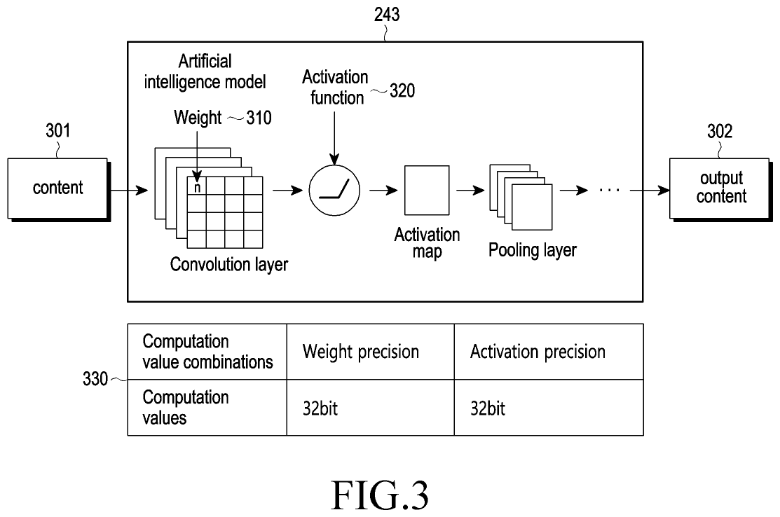

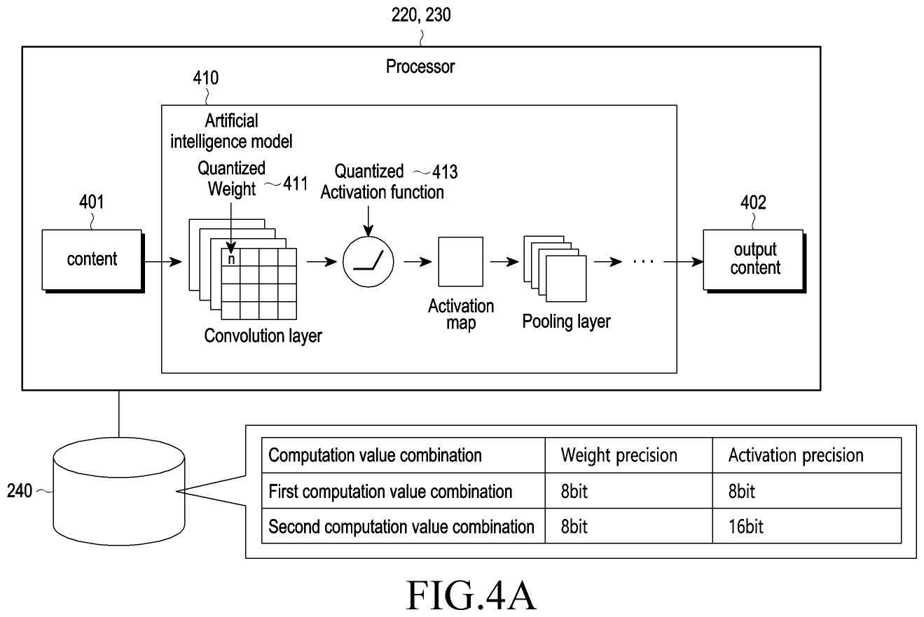

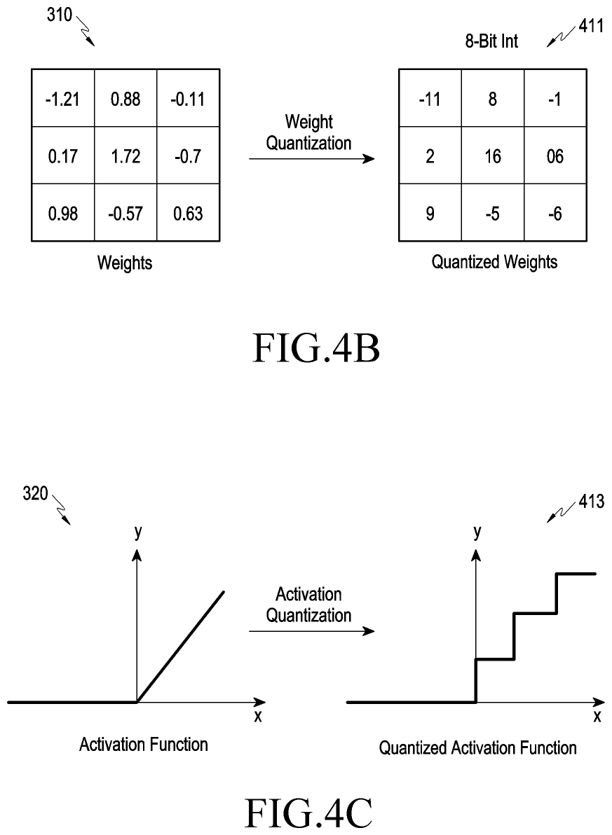

FIG. 2 is a view illustrating an example configuration of an electronic device 101 according to various embodiments. However, without being limited to the components illustrated in FIG. 2, the electronic device 101 may be implemented to include more or fewer components than those illustrated in FIG. 2. FIG. 2 is described below with reference to FIGS. 3 and 4A to 4C.

FIG. 3 is a view illustrating an example artificial intelligence model according to various embodiments. FIG. 4A is a view illustrating an example of a content processing operation based on an artificial intelligence model of a processor according to various embodiments. FIG. 4B is a view illustrating an example of an operation in which a parameter (e.g., weight) of an artificial intelligence model is obtained (or quantized) based on a computation value according to various embodiments. FIG. 4C is a view illustrating another example of an operation in which a parameter (e.g., activation function) of an artificial intelligence model is obtained (or quantized) based on a computation value based on a computation value according to various embodiments.

According to various embodiments, referring to FIG. 2, the electronic device 101 may include a data acquisition device 210, such as a camera 211, a microphone 213, and a communication circuit 215, a plurality of processors 220, a memory 240 storing a plurality of applications 241 and a plurality of artificial intelligence models 243, and a processor 230 including a computation value selection module 231 and an evaluation module 233. Hereinafter, each component included in the electronic device 101 is described.

First, the data acquisition device 210 according to various embodiments is described. The data acquisition device 210 may be interpreted as a logical concept for classifying devices for acquiring content among devices included in the electronic device 101. The data acquisition devices 210 may include various types of devices (e.g., various sensors or touch screens) for acquiring various types of contents described below in addition to the camera 211, the microphone 213, and the communication circuit 215.

According to various embodiments, the data acquisition devices 210 may obtain various types of data (or content) to be processed based on the artificial intelligence model. The various types of data may include media data, such as images, video, and audio data, and electronic documents but, without being limited thereto, may further include types of electronic data (e.g., software or sensor values) that may be analyzed electronically by an artificial intelligence model. In an embodiment, the data acquisition devices 210 may be driven according to the execution and/or driving of processes, programs, and/or applications installed (or stored) on the electronic device 101, obtaining various types of data. For example, when a camera application is executed and/or driven, the electronic device 101 may drive the camera 211 (e.g., performs an operation for controlling readout of the image sensor) to obtain images and/or videos as data. As another example, when a recording application is executed and/or driven, the electronic device 101 may drive the microphone 213 to obtain audio data, such as the user's utterance and/or ambient sounds, as data. As another example, when a web-based application is executed and/or driven, the electronic device 101 may establish a communication connection with a media server using the communication circuit 215 to obtain media data, such as images, video, and audio data. Hereinafter, examples of each content device are described.

According to various embodiments, the camera 211 (e.g., at least one front camera 211 and at least one rear camera 211) may capture still images (or images) and videos. According to an embodiment, at least one camera 211 may include one or more lenses, image sensors, image signal processors, or flashes. According to an embodiment, the electronic device 101 may include cameras 211 having different attributes or functions (or purposes). For example, the at least one camera 211 may include cameras 211 having different angles of view. Examples of the angles of view may include, but are not limited, super wide angles of 114° to 94°, wide angles of 75° to 66°, normal lens angles of 84° to 63°, telephoto angles of 28° to 8°, and super telephoto angles of 6° to 3°. As another example, at least one camera 211 may include at least one front camera 211 disposed on the front surface to capture images and/or videos and at least one rear camera 211 disposed on the rear surface to capture images and/or videos as described above.

According to various embodiments, the microphone 213 may receive sounds from the outside of the electronic device 101. For example, the electronic device 101 (e.g., the processor 230) may drive the microphone 213 to receive, through the microphone 213, sounds generated from the outside. The externally generated sounds may include speeches (or utterances) of speakers (e.g., the user and/or other speakers (or others)) and ambient (or background) noises. According to an embodiment, the microphone 213 may include a plurality of microphones 213. The electronic device 101 (e.g., the processor 230) may form beamforming to receive sounds generated from the electronic device 101 in a designated direction, from the sounds received using the plurality of microphones 213. The sounds in the designated direction obtained based on the received sounds may be defined as sub sounds. The plurality of microphones 213 may be disposed in the electronic device 101 to be spaced apart from each other at predetermined distances, and the sounds received through the microphones 213 may be signal-processed by the time or phase associated with the direction in which the sounds are to be obtained and the distances, thereby obtaining the sub sounds. Beamforming technology is well known, and is not described herein in detail.

According to various embodiments, the communication circuit 215 may establish a communication connection with an external electronic device (e.g., another electronic device or a server) in various kinds of communication schemes and transmit and/or receive data. As described above, the communication schemes may be performed by a communication scheme for establishing a direct communication connection, such as Bluetooth and Wi-Fi direct but without being limited thereto, may include communication schemes using access points (APs) (e.g., Wi-Fi communication) or communication schemes (e.g., 3G, 4G/LTE, or 5G) using cellular communications by way of base stations. The first communication circuit 215 may be implemented as the communication module 190 described above with reference to FIG. 1, so a redundant description thereof is omitted.

Hereinafter, a plurality of artificial intelligence models 243 and a plurality of processors 220 according to various embodiments are described.

First, a plurality of artificial intelligence models 243 are described.

According to various embodiments, each of the plurality of artificial intelligence models 243 is a model that has previously been trained based on a learning algorithm, and may be an artificial intelligence model that has previously been implemented to process various types of contents and output or (obtain) result data. For example, training may be performed on the electronic device 101 to use designated types of data as input data and output specific types of result data as output data based on a machine learning algorithm or deep learning algorithm to generate a plurality of artificial intelligence models 243 (e.g., machine learning models or deep learning models) that are then stored in the electronic device 101, or trained artificial intelligence models 243 may be transferred from an external electronic device 101 (e.g., an external server) and stored. The operation of training the artificial intelligence models is a well-known technique, and no detailed description thereof is thus given. The generated artificial intelligence models 243 may be implemented in the form of calculation graphs or intermediate representations (IRs) that need to be compiled, or native code that may be immediately executed, but are not limited thereto. According to an embodiment, in the case where artificial intelligence models are received (or downloaded) from an external server to the electronic device 101, the external server may be a server of a third party creating applications or a management server in which third parties register applications, and artificial intelligence models corresponding to functions to be provided through applications, along with the applications, may be registered in the external server. Thus, artificial intelligence models corresponding to applications, together with the applications, may be transferred from the external server to the electronic device 101, but embodiments are not limited thereto. The machine learning algorithms may include supervised algorithms, such as linear regression and logistic regression, unsupervised algorithms, such as clustering, visualization and dimensionality reduction, and association rule learning, and reinforcement algorithms, and the deep learning algorithms may include artificial neural networks (ANNs), deep neural networks (DNNs), and convolution neural networks (CNN) but, without being limited thereto, may further include other various learning algorithms. As an example, as shown in FIG. 3, a deep learning model may be generated based on a CNN, using image data and information about objects included in the image data as training data (e.g., that is, the image data is set as input data, and information about objects or subjects may be set as output data). The generated deep learning model may be implemented as to output result data 302, including information about the objects (e.g., instance segmentated image data), by processing the image data using the convolution layer, activation function (e.g., sigmoid or Relu), and pooling layer, in response to reception of the image data 301. Although not shown in FIG. 3, the deep learning model, that is trained based on the CNN, may include more layers in addition to the illustrated convolution layer and pooling layer, and this is well known technology and no detailed description thereof is thus given. As another example, without being limited to what is described in FIG. 3, another artificial intelligence model (e.g., a machine learning model or deep learning model) may be generated based on another learning algorithm, using audio data and information for speakers as training data (e.g., the audio data is set as input data, and the information for speakers is set as the output data), and the other artificial intelligence model may be implemented to output an identifier (e.g., a unique ID) for identifying the speaker as result data, in response to the reception of the audio data (e.g., a user utterance). Each of the plurality of artificial intelligence models 243 may be driven (or used) by a plurality of processors 220, which is described below.

According to various embodiments, each of the plurality of artificial intelligence models 243 may be implemented to include at least one parameter (e.g., weights 310 and activation functions 320) corresponding to values associated with a designated computational capability (e.g., or an operation capability, or processing capability, or calculation capability) (hereinafter, computation values, or computation value, or processing value, or calculation value) (e.g., the weight computation value (e.g., weight precision) has 32 bits, and the activation function computation value (e.g., activation function precision) has 32 bits). For example, referring to FIG. 3, the at least one parameter may include (or indicate) weights 310 constituting (or included in) a plurality of artificial intelligence models 243 generated by learning and an activation function 320 but, without being limited thereto, other various types of parameters constituting and/or implementing artificial intelligence models, such as gradients, may be further included. As another example, referring to 330 of FIG. 3, the values associated with the computation capability are values for the capability of computing such parameters as weights or activation function (e.g., sigmoid or Relu), and may include a computation value (e.g., weight precision) for the weight 310 and a computation value (e.g., activation precision) for the activation function 320. The values associated with computation capability may include 32 bits, 16 bits, 8 bits, and 4 bits, but without being limited thereto, may be set as other various values, and depending on the set values, formats and numerical ranges for computing the parameters may be determined. As an example, if the computation value for the weight 310 is set to 32 bits, the weights included in the convolution layer may be computed as floating-point numbers (32-bit float), with the significand of 24 bits and the exponent of 8 bits. Other formats and numerical ranges that may be represented based on other computation values are well known and thus are not described in detail. Thus, in the case where learning is performed, with the computation value (e.g., weight precision) for the weight 310 set to have 32 bits, and the computation value (e.g., activation precision) for the activation function 320 set to have 32 bits as illustrated in FIG. 3, the generated artificial intelligence model may include weights 310 represented (or computed) in 32 bits and an activation function 320 represented (or computed) in 32 bits. According to an embodiment, the computation values associated with the plurality of artificial intelligence models 243 may be set to be equal to or higher than computation values (or computation values individually set to the plurality of processors 220) available on the electronic device 101 described below.

Although it has been described and/or shown that the electronic device 101 uses a plurality of artificial intelligence models 243 previously stored in the electronic device 101, embodiments are not limited thereto and, according to various embodiments, the electronic device 101 may receive corresponding artificial intelligence models 243 from an external server based on the driving of an application. Or, according to various embodiments, the electronic device 101 may transmit, to the external server, information about content and information for processing content (e.g., information about a mode for distinguishing objects (or subjects) and selected computation values) and receive, from the external server, result data processed by an artificial intelligence model previously stored in the external server, instead of performing the operation of processing content using an artificial intelligence model.

The plurality of processors 220 are described below.

According to various embodiments, as illustrated in FIG. 4A, each of a plurality of processors 220 may be implemented to obtain result data (or content) 402 output from a plurality of artificial intelligence models 243 by processing data (or content) 401 input using an artificial intelligence model quantized for a specific artificial intelligence model among a plurality of artificial intelligence models 243 stored in the electronic device 101. However, without being limited to what is described, each of the plurality of processors 220 may obtain result data (or content) 402 by processing data (or content) 401 based on the plurality of artificial intelligence models 243, or may use a pre-quantized artificial intelligence model. For example, the plurality of processors 220 may include at least one of an application processor (AP), a central processing unit (CPU), a graphic processing unit (GPU), a display processing unit (DPU), or a neural processing unit (NPU) but, without being limited thereto, may include various types of processors. In this case, in the disclosure, a plurality of cores included in one processor may also be understood as processors. For example, when the DSP is implemented to include a plurality of cores, the plurality of cores may be understood as the plurality of processors 220. Each of the plurality of processors 220 may be implemented to select at least one artificial intelligence model associated with an executed and/or driven program, process, or application among the plurality of artificial intelligence models 243 based on the execution and/or driving of the application and process contents obtained by the data acquisition device 210 using the selected artificial intelligence model, obtaining result data. The operation of processing contents using the artificial intelligence models of the plurality of processors 220 may be performed in the background. According to an embodiment, upon selecting one of the plurality of the plurality of processors 220, the electronic device 101 may compile, using a compiler (e.g., TVM), the artificial intelligence model so that the artificial intelligence model may be executed by the selected processor when the stored artificial intelligence model is in the form of a graph or thereby obtaining native kernel equipped with executable native code and transferring it to the selected processor. The selected processor may run the artificial intelligence model by executing the kernel.

According to various embodiments, the electronic device 101 may store information about computation values for each type of parameter available to each of the plurality of processors 220. The plurality of computation values available to the plurality of processors 220 may be set to be equal to or smaller than a plurality of computation values (e.g., 32 bits) associated with the plurality of artificial intelligence models 243. As an example, computation values for weights and computation values for activation function may be set as a plurality of combinations (or a plurality of sets) as shown in Table 1 below. However, without being limited to Table 1, computation values for weights (weight precision) and computation values for activation function (activation precision) may be set variously.

TABLE 1

| Computation value | Weight | Activation |
|---|---|---|
| combinations(or sets) | Precision | Precision |
| First computation value | 32 bits | 32 bits |
| combination | | |
| Second computation value | 16 bits | 16 bits |
| combination | | |
| Third computation value | 16 bits | 16 bits |
| combination | | |
| Fourth computation value | 8 bits | 16 bits |
| combination | | |
| Fifth computation value | 8 bits | 8 bits |
| combination | | |
| Sixth computation value | 4 bits | 4 bits |
| combination | | |

According to various embodiments, each of the plurality of processors 220 may change (or set) parameters (e.g., at least one of weights or activation function) included in the plurality of artificial intelligence models 243 based on a computation value equal to or smaller than the computation values associated with the plurality of artificial intelligence models 243 and process content using an artificial intelligence model 410 having the changed parameters (e.g., the quantized weight 411 and quantized activation function 413). As an example, referring to FIG. 4B, the weights 310 of the convolution layer corresponding to the 32-bit computation value of the artificial intelligence models 243 may be reconstructed and/or reimplemented as weights 411 corresponding to a lower computation value (e.g., 8 bit int). As another example, referring to FIG. 4C, the activation function 320 of the artificial intelligence model 243 implemented to output the value corresponding to the 32-bit computation value may be reconstructed and/or reimplemented as an activation function 413 implemented to output a value corresponding to a lower, 4-bit computation value. The parameter-changed artificial intelligence model 410 and parameter-unchanged artificial intelligence model may be distinguished from each other by the terms “first” and “second” (e.g., a deep learning model previously stored in the electronic device 101, and a parameter-changed “first” deep learning model). Changing a parameter, such as weight or activation function, of the pre-trained artificial intelligence model 243 into a unit and range corresponding to a relatively lower computation value may be defined as quantization. Quantization is a well-known technique and is not further described. According to an embodiment, each of the plurality of processors 220 may receive information about the computation values per parameter type (e.g., weight and activation function) selected by the processor 230 and quantize the pre-stored artificial intelligence model based on the received information about the per-parameter type computation values and use them. According to an embodiment, each of the plurality of processors 220 may obtain and use a pre-quantized artificial intelligence model based on the per-parameter type computation values selected by the processor 230. Or, without limitations thereto, each of the plurality of processors 220 may be pre-configured to use computation values designated per parameter type and, if one of the plurality of processors 220 is selected, the selected processor may be implemented to use the quantized artificial intelligence model based on the per-parameter type (e.g., weight and activation function) designated computation values set to corresponding to the processor. As the electronic device 101 processes content using the quantized artificial intelligence model 410, computational loads may be reduced, mitigating operation loads of artificial intelligence models. An example of the processor 230 is described below. For ease of description, the processor set forth below is described and/or shown to be distinguished from the plurality of processors 220 described above. However, the processor may be a processor included in the plurality of processors 220 or, without being limited thereto, the processor may be a processor implemented separately from the plurality of processors not to perform the operation of processing content based on an artificial intelligence model.

According to various embodiments, the processor 230 may include at least one of an AP, a CPU, a GPU, a DPU, or an NPU. At least some of the modules (e.g., a computation parameter selection module 231 and an evaluation module 233) included in the processor 230 may be implemented (e.g., executed) in software, firmware, hardware, or a combination of at least two or more thereof. For example, the modules may be implemented in the form of an application, program, computer code, instructions, routines, or processes, which are executable by the processor 230. Thus, when the modules are executed by the processor 230, the modules may trigger the processor 230 to perform operations associated with the modules (or functions that the modules may provide). Or, the modules may be implemented as portions of a specific application. Or, without being limited to what is described and/or shown, each module may be implemented as a separate hardware device (e.g., a processor or control circuit) from the processor 230.

According to various embodiments, the computation value selection module 231 may select one from among a plurality of values associated with computation capability per parameter type (e.g., weight or activation function) to use an artificial intelligence model to process content. For example, the plurality of computation values may be set to 32 bits, 16 bits, 8 bits, and 4 bits, but without being limited thereto, may be set to other values. According to an embodiment, the computation value selection module 231 may select (or identify) preset computation values (e.g., weight precision is 8 bits, and the activation precision is 8 bits) from among the plurality of computation values per parameter type (e.g., weight or activation function) when an event for processing content occurs (e.g., an application is executed and/or driven). According to an embodiment, the computation value selection module 231 may select a processor corresponding to the computation values (e.g., the computation value for weight (weight precision) or computation value for activation function (activation precision)) selected from among the plurality of processors 220 based on information about the computation values per parameter type (e.g., weight or activation function) set for the plurality of processors 220. According to an embodiment, the computation value selection module 231 may select one from among the plurality of processors 220 and transfer information about the selected computation values to the selected processor as described above. Further, without being limited thereto, the computation value selection module 231 may, without performing the computation of selecting computation values, select a processor from among the plurality of processors 220 and control the selected processor to use an artificial intelligence model quantized based on the computation values corresponding to the processor. According to an embodiment, the computation value selection module 231 may change the currently selected computation values into other computation values (or change the selected processor into another processor) based on the cost calculated by the evaluation module 233 which is described below. The computation of the electronic device 101 based on the computation value selection module 231 is described below in detail.

According to various embodiments, the evaluation module 233 may calculate a cost associated with candidate computation values among the plurality of computation values based on an occurrence of a designated event. The computation of calculating a cost based on the evaluation module 233 by the electronic device 101 is described below in detail.

An example of an computation of an electronic device 101 is described below according to various embodiments.

According to various embodiments, the electronic device 101 may select computation values from among a plurality of computation values to process data, set (or quantize) parameters (e.g., weights or activation functions) of an artificial intelligence model based on the selected computation values, and use the artificial intelligence model. The electronic device 101 may change the selected computation values into other computation values among the plurality of computation values based on an occurrence of a designated event while processing data using the artificial intelligence model and set (or quantize) the parameters of the artificial intelligence model based on the changed computation values, and use the artificial intelligence model.

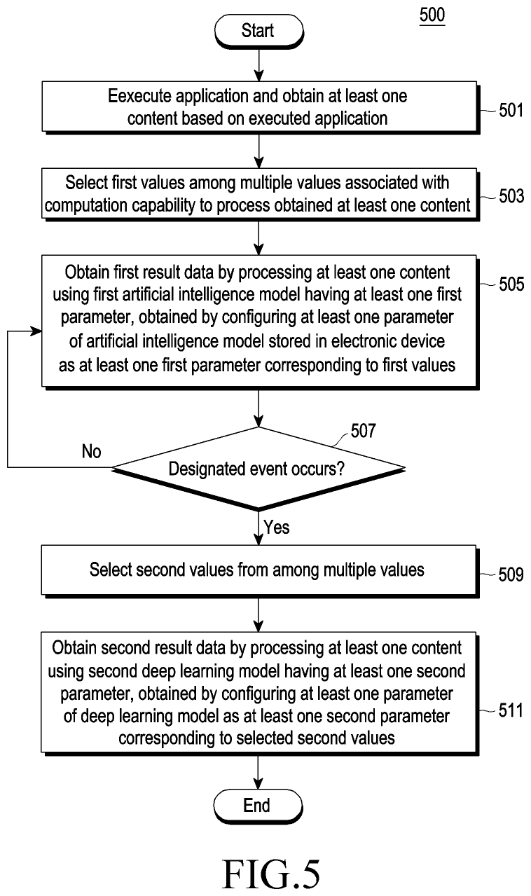

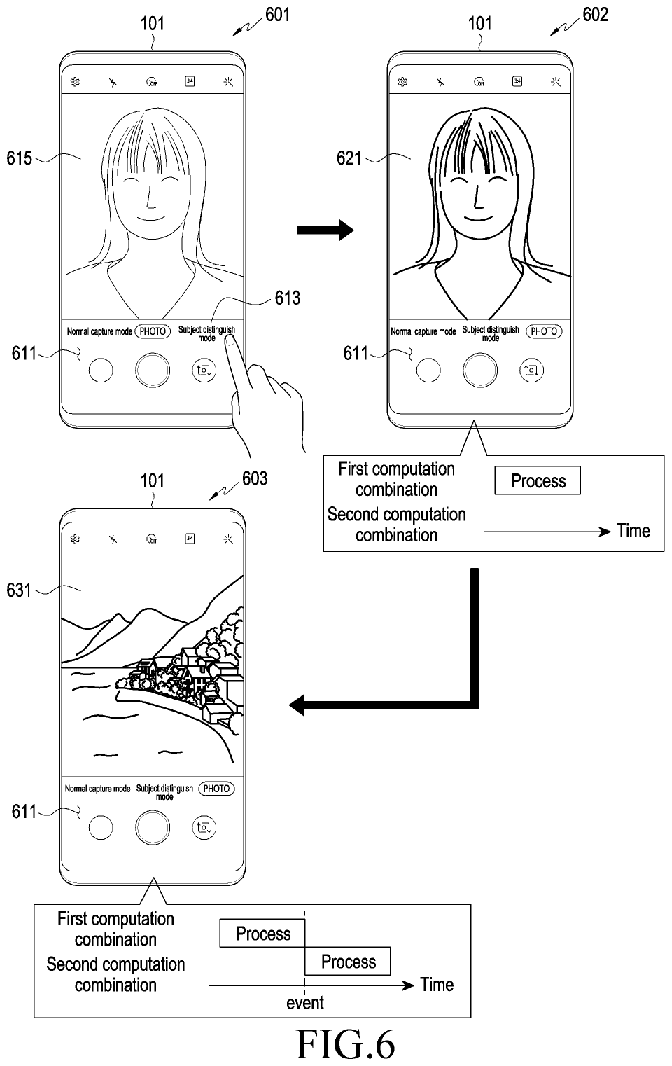

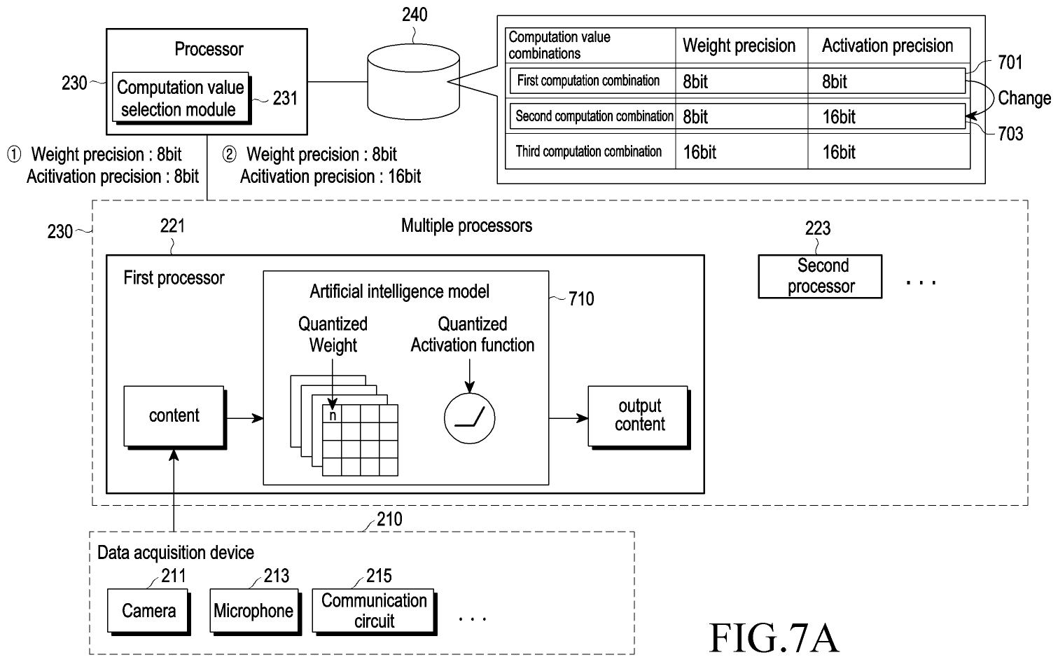

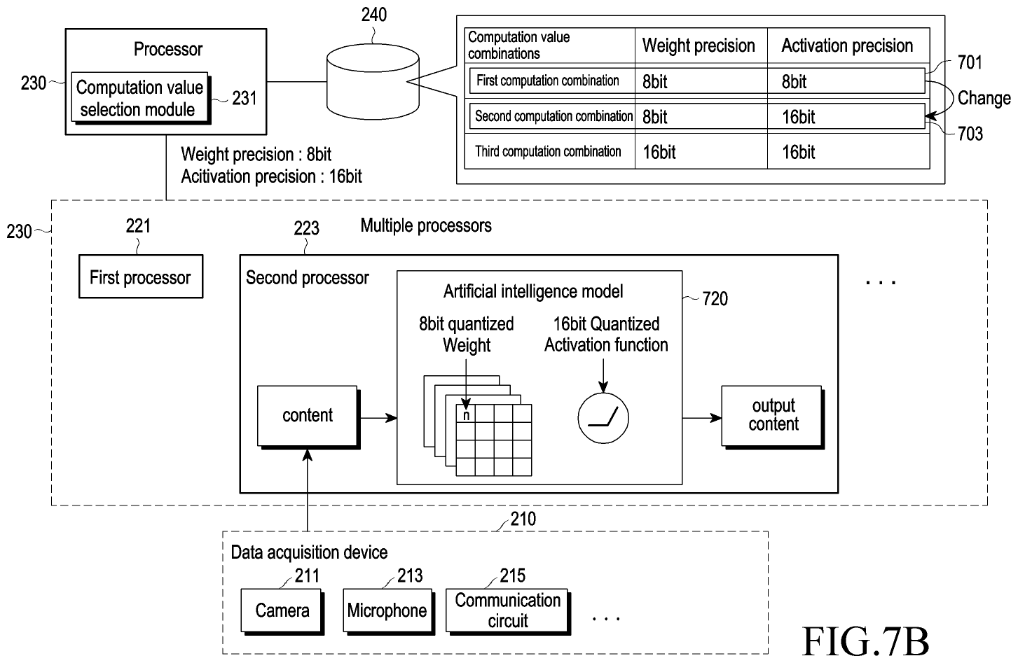

FIG. 5 is a flowchart 500 illustrating an example of an operation of an electronic device 101 according to various embodiments. The operations shown in FIG. 5 are not limited to the shown order but may rather be performed in other various orders. According to various embodiments, more or less operations than those of FIG. 5 may be performed. FIG. 5 is described below with reference to FIGS. 6 and 7A and 7B.

FIG. 6 is a view illustrating an example of an operation of processing data (e.g., image data) using an artificial intelligence model by an electronic device 101 according to various embodiments. FIG. 7A is a view illustrating an example of an operation using an artificial intelligence model by selecting or changing computation values among a plurality of computation values by an electronic device 101 according to various embodiments. FIG. 7B is a view illustrating an example of an operation of using an artificial intelligence model by selecting or changing a processor among a plurality of processors 220 by an electronic device 101 according to various embodiments.

According to various embodiments, in operation 501, the electronic device 101 may execute an application and obtain at least one data based on the executed application. For example, the electronic device 101 may execute one among a plurality of applications 241 installed on the electronic device 101 and drive a device equipped in the electronic device 101 based on the executed application, thereby obtaining data. As an example as shown in state 601 of FIG. 6, the electronic device 101 may execute a camera application 611 and drive a camera 211 based on the executed camera application 611, obtaining images or videos 615. Further, without being limited to what is described and/or illustrated, as described above in connection with FIG. 2, the data obtainable by the electronic device 101 may include audio data and electronic documents, but without being limited thereto, may further include electronic data (e.g., software or sensor values) of types electronically analyzable by an artificial intelligence model. Accordingly, the electronic device 101 may execute and/or drive various types of applications (e.g., a recording application, word-processor application), processes, or programs for acquiring various types of data and obtain data using a device (e.g., the microphone 213, communication circuit 215, touchscreen (not shown), or sensor (not shown)).

According to various embodiments, in operation 503, the electronic device 101 may select first values from among a plurality of values associated with computation capability so as to process at least one data (or content) obtained. For example, when an event for processing the at least one obtained data (or content) (e.g., an image or video) occurs, the electronic device 101 may select computation values to be used for processing data (or content) from among a plurality of per-parameter type (e.g., weight and activation function) computation values. For example, the processing of data (or content) may include the computation of obtaining information associated with the obtained data (or content) based on the data (or content). The information associated with the obtained data (or content) may include information analyzable from the obtained data (or content). For example, when the data (or content) is image data or video data, the processing of data (or content) may include the operation of obtaining information about obtains (or subjects) from the image data as shown in states 601 and 602 of FIG. 6. As an example, although not shown, if the data (or content) is audio data, the processing of data (or content) may include the operation of obtaining identification information for the speaker based on the audio data. The occurrence of the event for processing the data (or content) may be identified based on an executed and/or driven application (or program or process) by the electronic device 101. For example, modes for processing types of data (or content) obtained per application may previously be implemented in the applications. As an example, as shown in state 601 of FIG. 6, the camera application 615 may be implemented to provide a “subject distinguish mode” 613, which processes the captured image or video and obtain information about objects (or subjects). Thus, if the mode 613 is selected on the execution screen of the camera application 615 by the user, the electronic device 101 may identify that an event requesting processing of the image (or content) has occurred.

According to various embodiments, the electronic device 101 may obtain (or select) an artificial intelligence model 710 for processing data (or content) (or corresponding to the selected mode). The plurality of artificial intelligence models 243 may be models pre-trained to process designated types of data (e.g., image data) (e.g., output result data in which subjects have been distinguished) as described above in connection with FIG. 4A. For example, the electronic device 101 may identify an artificial intelligence model 710 pre-trained to process the type of data (or content) corresponding to the event (or mode) among the plurality of artificial intelligence models 243 pre-stored in the electronic device 101, based on the occurrence of an event for processing the data (or content) (e.g., mode selection). Or, without being limited thereto, as described above, the electronic device 101 may receive an artificial intelligence model for processing the type of data (or content) corresponding to the event from an external server based on the occurrence of the event (e.g., mode selection).

According to various embodiments, the electronic device 101 may select computation values corresponding to a computation value combination to be used for processing the data (or content) from among a plurality of pre-stored computation values (e.g., the plurality of computation value combinations shown in Table 1). For example, the electronic device 101 (e.g., the computation value selection module 231) may select preset per-parameter type computation values (e.g., weight precision is 8 bits, and activation precision is 8 bits) 701 from among a plurality of per-parameter type (e.g., weight and activation function) computation values pre-stored in the electronic device 101 as illustrated in FIG. 7A. The plurality of computation values are values associated with computation capability for computing (or setting) parameters (e.g., at least one of weights or activation functions) of the artificial intelligence model as described above in connection with FIGS. 3 and 4 and may be set to values, e.g., 32 bits, 16 bits, 8 bits, or 4 bits, which are equal to or smaller than the computation value (e.g., 32 bits) of the artificial intelligence model 710, but are not limited thereto. The combinations of the per-parameter type (e.g., weight and activation function) computation values have been described above in connection with Table 1 above, and no duplicate description thereof is given for the sake of brevity. According to an embodiment, the electronic device 101 (e.g., the computation value selection module 231) may select preset computation values (e.g., weight precision is 8 bits, and activation precision is 8 bits) 701 from among the plurality of per-parameter type (e.g., weight and activation function) computation values based on an occurrence of an event for processing data (or content) as shown in FIG. 7A. For example, it may be preconfigured to select combinations of the lowest per-parameter type (e.g., weight and activation function) computation values as illustrated in FIG. 7A but, without being limited thereto, computation values selected may be preset in other various manners (e.g., intermediate computation value or highest computation value is selected). According to an embodiment, the electronic device 101 (e.g., the computation value selection module 231) may select computation values from among the plurality of per-parameter type (e.g., weight and activation function) computation values based on the type of data (or content) currently received. For example, complexities indicating the computational loads for processing data (or content) may be set depending on the types of data (or content), and the electronic device 101 (e.g., the computation value selection module 231) may select the per-parameter type (e.g., weight and activation function) computation values in proportion to the complexities. For example, the complexity of image data may be set to be higher than the complexity of audio data. Thus, upon receiving image data, the electronic device 101 (e.g., the computation value selection module 231) may select first computation values from among the plurality of per-parameter type (e.g., weight and activation function) computation values and, upon receiving audio data, select second computation values, which are lower than the first computation values, from among the plurality of per-parameter type (e.g., weight and activation function) computation values.

According to various embodiments, in operation 505, the electronic device 101 may obtain first result data by processing at least one data (or content) using a first artificial intelligence model having at least one first parameter, obtained by configuring at least one parameter of an artificial intelligence model stored in the electronic device 101 as at least one first parameter corresponding to the first values. For example, the electronic device 101 may control (or transmit instructions to) one of the plurality of processors 220 to process data (or content) using an artificial intelligence model 710 quantized based on the selected per-parameter type (e.g., weight and activation function) computation values and obtain result data of the processing. For example, as shown in state 602 of FIG. 6, the electronic device 101 may obtain result data 621, where an object included in the image data is identified, by processing the obtained image data 615 using the quantized artificial intelligence model 710. The quantization may be to change (or set) parameters (e.g., weight and activation function) constituted of higher computational values constituting (or included in) the artificial intelligence model 243 into parameters constituted of lower computation values. For example, the electronic device 101 may set (or change or configure) parameters (e.g., weight and activation function) of an artificial intelligence model pre-implemented to process data (or content) (e.g., implemented to receive image data and output result data where an object is identified), as first parameters (e.g., first weight and first activation function) based on selected computation values and control the selected first processor 221 to process data (or content) using the artificial intelligence model 710 having the first parameters. For example, as described above in connection with FIGS. 4B and 4C, the electronic device 101 may process data (or content) using the artificial intelligence model 710 having the changed weight and activation function.

According to various embodiments, the electronic device 101 may select at least one processor to process data (or content) from among a plurality of processors 220 as shown in FIG. 7A. According to an embodiment, the processor may identify processors not performing the data (or content) processing operation among the plurality of processors 220 (or identify idle processors), select a preset processor from among the identified processors, randomly select a processor, or select a processor corresponding to the type of the received data (or content) (e.g., select a GPU if the data (or content) is image data), and control (or provide instructions to) the selected processor (e.g., the first processor 221) to process the data (or content) using the quantized artificial intelligence model 710. According to an embodiment, the electronic device 101 (e.g., the processor) may select a processor (e.g., the first processor 221) corresponding to the selected computation value (e.g., 8 bits) for weight and computation value (e.g., 8 bits) for activation function (or implemented to compute with the computation values) from among the plurality of processors 220 and control (or provide instructions to) the selected processor to process data (or content) using the quantized artificial intelligence model 710. As described above, information about the computation value for weight and computation value for activation function that are used for each of the plurality of processors 220 may be previously stored in the electronic device 101 as described above. The electronic device 101 (e.g., the processor 230) may select the processor (e.g., the first processor 221) corresponding to the selected computation value (e.g., 8 bits) for weight and computation value (e.g., 8 bits) for activation function (or implemented to compute with the computation values) from among the plurality of processors 220 by referring to the information.

According to various embodiments, the selected processor (e.g., the first processor 221) may use a pre-quantized artificial intelligence model 710 or may quantize an artificial intelligence model based on the selected per-parameter type computation values and use the quantized artificial intelligence model. According to an embodiment, the processor 230 may transfer the information about the selected computation value (e.g., 8 bits) for weight and computation value (e.g., 8 bits) for activation function to the first processor 221 as shown in FIG. 7A. The first processor 221 may change (or configure or set) the parameters (e.g., weight and activation function) of the artificial intelligence model based on the computation value (e.g., 8 bits) for weight and computation value (e.g., 8 bits) for activation function, input data (or content) to the artificial intelligence model including the changed parameters, and obtain result data that is output as a response to processing (e.g., convolution layer computation, activation function computation, or pooling layer computation) the input data (or content). In this case, as described above, the first processor 221 may execute a kernel generated by compiling the quantized artificial intelligence model 710, but is not limited thereto. According to an embodiment, the processor 230 may control the selected first processor 221 to process data (or content) using an artificial intelligence model quantized based on the computation value (e.g., 8 bits) for weight and computation value (e.g., 8 bits) for activation function, selected from among pre-quantized artificial intelligence models. For example, the electronic device 101 may previously implement (or generate) quantized artificial intelligence models by quantizing pre-trained artificial intelligence models with the computation values of the combinations as described above in connection with Table 1 and store the quantized artificial intelligence models. The electronic device 101 (e.g., the processor 230) may identify the artificial intelligence model 710 corresponding to the selected per-parameter computation values among the quantized artificial intelligence models and control the first processor 221 to process data (or content) based on the identified artificial intelligence model. In this case, the processor 230 may transfer a kernel generated by compiling the quantized artificial intelligence model 710 to the first processor 221 and enable the first processor 221 to perform processing operations based on the artificial intelligence model 710 as described above. However, embodiments are not limited thereto.

According to various embodiments, the electronic device 101 may determine whether a designated event occurs in operation 507. In an embodiment, the occurrence of the designated event may include the lapse of a preset time. For example, the electronic device 101 may set a timer from the time of processing data (or content) using the first processor 221 among the plurality of processors 220 and, upon identifying the lapse of a preset time based on the timer, identify that the designated event occurs. After an evaluation period described below, if the lapse of the preset time is identified again, the electronic device 101 may identify an occurrence of the designated event. According to an embodiment, the occurrence of the designated event may include a change to the characteristics of obtained data (e.g., image data) as shown in states 602 to 603 of FIG. 6. For example, the characteristics of the data may include values included in the data or the type of the data. For example, the electronic device 101 may obtain new image data according to a capturing of a subject different from the subject being captured or a different landscape from the landscape being captured as shown in states 602 and 603 of FIG. 6 and identify that the difference between a value (e.g., pixel values) included in the currently obtained image data and a value (e.g., a pixel value) included in the previously obtained image data 615 is a preset value or more. Based on the identification of the difference of the preset value or more, the electronic device 101 may identify that the characteristics of the image data currently received are changed and identify that the designated event occurs. According to an embodiment, the occurrence of the designated event may be identifying a movement of the electronic device 101. For example, the electronic device 101 may identify an occurrence of the designated event upon identifying a movement (e.g., rotation) of the electronic device 101 based on the value identified from a sensor (e.g., a tilt sensor or gyro senor).

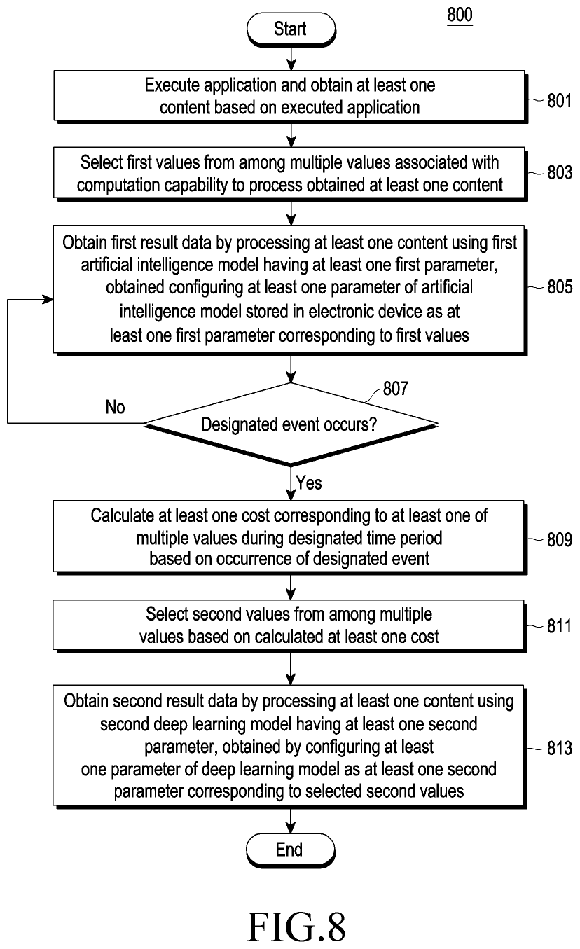

According to various embodiments, upon determining that the designated event occurs, the electronic device 101 may select second values from among the plurality of values in operation 509. For example, as illustrated in FIG. 7B, the electronic device 101 may select a different combination of values (e.g., a second computation combination 703) different from the currently selected combination of values (e.g., the first computation combination 701), from among the plurality of computation value combinations based on the occurrence of the designated event. If the designated event occurs, the electronic device 101 may set the mode of the electronic device 101 to be a “result evaluation mode,” perform the operation of calculating costs for other computation combinations than the currently selected computation combination (e.g., the first computation combination 701) during a designated period, and select a different, second computation combination 703 from among the plurality of computation combinations based on the calculated costs. The calculated cost may indicate the difference in result data based on the computation combinations and energy consumption, and the operation of calculating the cost by the electronic device 101 and the operation of selecting a different computation combination based on the calculated cost are described below with reference to FIGS. 8 to 11.

According to various embodiments, when a computation combination changes, the electronic device 101 may change the computation combinations in a designated order. According to an embodiment, referring to FIGS. 7A and 7B, changing the computation combinations in the designated order may be changing the current combination into another combination step by step. For example, the steps of the combinations may be set in proportion to the per-parameter type (e.g., weight and activation function) computation values corresponding to the combinations. Thus, as the sum of the computation value for weight and the computation value for activation function decreases, the steps of computation combinations may reduce and, as the sum increases, the steps of computation combinations may increase. The term “step” may be replaced with the term “level.” As illustrated in FIGS. 7A and 7B, the electronic device 101 may select a computation combination (e.g., the second computation combination 703) which is one step higher than the current computation combination (e.g., the first computation combination 701) or may select a one-step lower computation combination. According to another embodiment, computation combinations may be changed by more than one step.

According to another embodiment, the step in which the computation combination is changed may be proportional to the difference between the previously received data (or content) and the currently received data (or content). As described above, when the electronic device 101 changes computation combinations in a designated order, the electronic device 101 may identify computation combinations (i.e., candidate computation combinations) corresponding to the steps to which the current step may be changed (e.g., when it is changed one step at a time, a one-step higher step and/or a one-step lower step) and calculate costs for the identified computation combinations. Without being limited thereto, if the electronic device 101 changes computation combinations without a designated order, the electronic device 101 may calculate costs for at least some of the plurality of computation combinations without performing the operation of identifying the candidate computation combinations as described above.

According to various embodiments, in operation 511, the electronic device 101 may obtain second result data by processing at least one data (or content) using a second deep learning model having at least one second parameter, obtained by configuring the at least one parameter of the deep learning model as at least one second parameter corresponding to the selected second values. For example, the electronic device 101 may control (or transmit instructions to) one of the plurality of processors 220 to process data (or content) using an artificial intelligence model 720 quantized based on newly selected per-parameter type (e.g., weight and activation function) computation values and obtain result data of the processing. According to an embodiment, the electronic device 101 may control the processor (e.g., the first processor 221) performing the operation of processing the current data (or content) to process data (or content) using the second artificial intelligence model 720 having the parameter corresponding to the newly selected per-parameter type (e.g., weight and activation function) computation values (e.g., weight precision is 8 bits, and activation precision is 16 bits) 703 as shown in FIG. 7A. For example, as described above, the first processor 221 may receive the newly selected per-parameter type computation values from the processor 230, quantize a pre-trained artificial intelligence model based on the newly selected per-parameter type (e.g., weight and activation function) computation values, or transfer a quantized artificial intelligence model 720 corresponding to the newly selected per-parameter type (e.g., weight and activation function) computation values, pre-stored in the electronic device 101, to the first processor 221. According to an embodiment, as illustrated in FIG. 7B, the electronic device 101 may control a processor (e.g., a second processor 223), different from the processor (e.g., the first processor 221) performing the operation of processing the current data (or content), to process data (or content) using the second artificial intelligence model having the parameter corresponding to the newly selected per-parameter type (e.g., weight and activation function) computation values (e.g., weight precision is 8 bits, and activation precision is 16 bits) 703. For example, the electronic device 101 may identify the second processor 223 corresponding to the newly selected per-parameter type (e.g., weight and activation function) computation values 703 (or set to use the corresponding computation values) among the plurality of processors 220 and control the second processor 223 to process data (or content) using the second artificial intelligence model 720 having the parameter corresponding to the newly selected per-parameter type (e.g., weight and activation function) computation values (e.g., weight precision is 8 bits and activation precision is 16 bits) 703. Thus, as shown in state 603 of FIG. 6, the electronic device 101 may obtain result data 631 for image data having different characteristics (e.g., image data in which an object or landscape has been changed). The operation of obtaining a quantized artificial intelligence model and processing data (or content) using the artificial intelligence model by the electronic device 101 in operation 511 may be performed as in operation 505 by the electronic device 101 as described above, and no duplicate description thereof is thus given for the sake of brevity.

Although it has been described and/or shown that the electronic device 101 uses a plurality of artificial intelligence models 243 previously stored in the electronic device 101, embodiments are not limited thereto and, according to certain embodiments, the electronic device 101 may receive a corresponding artificial intelligence model from an external server based on a driving of an application, quantize and use the received artificial intelligence model, or receive a pre-quantized artificial intelligence model from an external server and use it. Or, according to various embodiments, the electronic device 101 may transmit, to the external server, information about data (or content) and information for processing data (or content) (e.g., information about a mode for distinguishing objects (or subjects) and selected computation values) and receive, from the external server, result data processed by an artificial intelligence model previously stored in the external server, instead of performing the operation of processing data (or content) using an artificial intelligence model.

An example of an operation of an electronic device 101 is described below according to various embodiments. The above-described example operation of the electronic device 101 may be applied to an example operation of the electronic device 101 described below, and no duplicate description is thus presented for the sake of brevity.

According to various embodiments, when a designated event occurs, the electronic device 101 may calculate costs for at least some of a plurality of computation combinations during a designated period (e.g., an evaluation period) and select another computation combination based on the calculated costs.

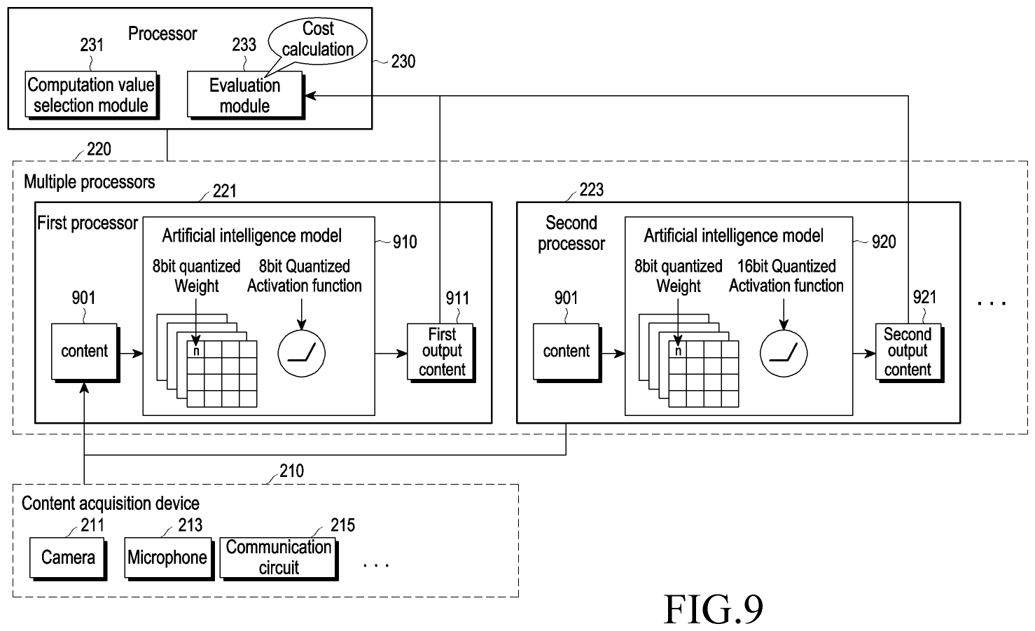

FIG. 8 is a flowchart 800 illustrating an example of an operation of an electronic device 101 according to various embodiments. The operations shown in FIG. 8 are not limited to the shown order but may rather be performed in other various orders. According to various embodiments, more or less operations than those of FIG. 8 may be performed. FIG. 8 is described below with reference to FIGS. 9, 10, and 11A and 11B.

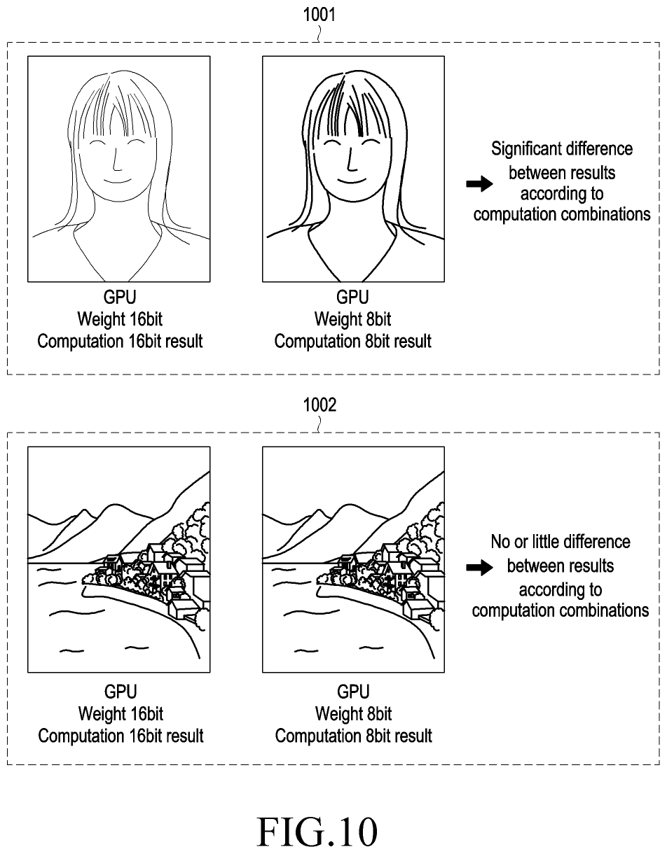

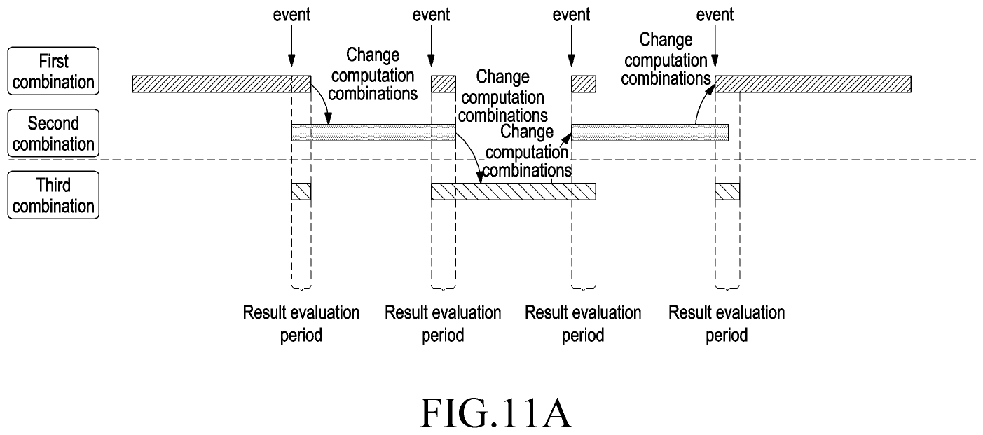

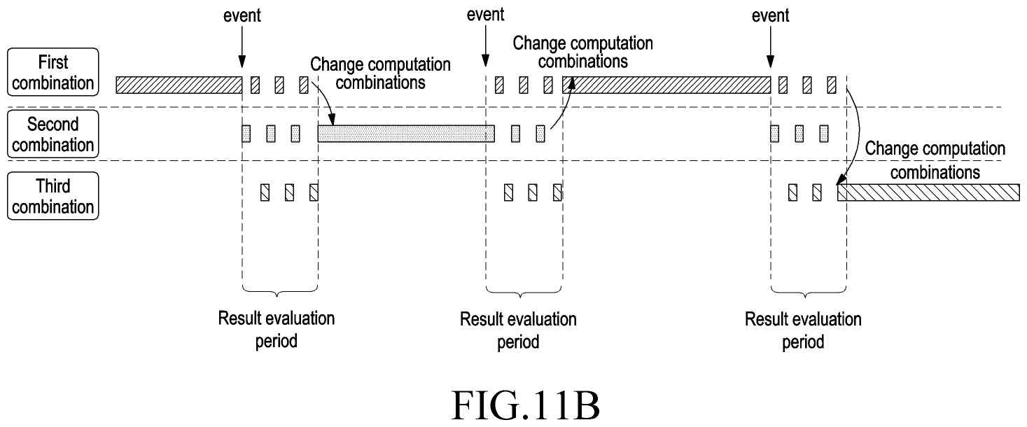

FIG. 9 is a view illustrating an example of an operation of calculating a cost for each of a plurality of computation combinations by an electronic device 101 according to various embodiments. FIG. 10 is a view illustrating an example of result data obtained by artificial intelligence models having at least one parameter configured based on different computation combinations according to various embodiments. FIG. 11A is a view illustrating an example of an operation of calculating costs during a designated period by an electronic device 101 according to various embodiments. FIG. 11B is a view illustrating another example of an operation of calculating costs during a designated period by an electronic device 101 according to various embodiments.

According to various embodiments, in operation 801, the electronic device 101 may execute an application and obtain at least one data (or content) based on the executed application. For example, the electronic device 101 may execute an application (e.g., a camera application) among a plurality of applications 241 installed on the electronic device 101 and drive a device (e.g., a camera 211) equipped in the electronic device 101 based on the executed application, obtaining data (or content) (e.g., image data). Operation 801 of the electronic device 101 may be performed like operation 501 of the electronic device 101 as described above, and no duplicate description thereof is given below for the sake of brevity.

According to various embodiments, in operation 803, the electronic device 101 may select first values from among a plurality of values associated with computation capability so as to process the obtained at least one data (or content) and, in operation 805, the electronic device 101 may obtain first result data (or content) by processing at least one data (or content) using a first artificial intelligence model having at least one first parameter, obtained by configuring at least one parameter of an artificial intelligence model stored in the electronic device 101 as at least one first parameter corresponding to the first values. For example, if an event for processing at least one obtained data (or content) (e.g., image or video) occurs (e.g., a mode for obtaining information about objects (or subjects) is selected on the camera application), the electronic device 101 (e.g., the computation value selection module 231) may select preset computation values to be used for processing data (or content) from among a plurality of per-parameter type (e.g., weight and activation function) computation values (e.g., the types of computation values described above in connection with Table 1). As another example, the electronic device 101 may obtain (or select) an artificial intelligence model for processing data (or content) (or corresponding to the selected mode). As another example, the electronic device 101 may select at least one processor to process data (or content) from among the plurality of processors 220 and control the selected processor (e.g., the first processor 221) to process data (or content) using a quantized artificial intelligence model including at least one parameter set based on the selected computation values. Operations 803 to 805 of the electronic device 101 may be performed like operations 503 to 505 of the electronic device 101 as described above, and no duplicate description thereof is given below for the sake of brevity.

According to various embodiments, the electronic device 101 may determine whether a designated event occurs in operation 807. For example, the occurrence of the designated event may include at least one of the lapse of a designated time, a change to the characteristics of the obtained data (or content), or movement of the electronic device 101 as described above. Operation 807 of the electronic device 101 may be performed like operation 507 of the electronic device 101 as described above, and no duplicate description thereof is given below for the sake of brevity.

According to various embodiments, in operation 809, the electronic device 101 may calculate at least one cost corresponding to at least one of the plurality of values during a designated time interval based on the occurrence of the designated event and, in operation 811, select second values from among the plurality of values based on the at least one calculated cost. For example, during a designated period (e.g., an evaluation period), the electronic device 101 may calculate costs associated with some of the plurality of computation combinations. and select a computation combination (e.g., a second computation combination) having the lowest cost from among the calculated costs. For example, as illustrated in FIGS. 11A and 11B, the electronic device 101 may change into the computation combination having the lowest cost after the designated period, based on the costs calculated during the designated period and process data (or content). In this case, the computation combination having the lowest cost may be the currently selected computation combination (e.g., the first computation combination) or a computation combination (e.g., the second computation combination) different from the currently selected computation combination. According to an embodiment, the electronic device 101 may calculate costs for all of the plurality of computation combinations including the current computation combination during the designated period. According to an embodiment, the electronic device 101 may also calculate the costs for the current computation combination during the designated period, and candidate computation combinations (e.g., the computation combination which is one step lower or higher than the current computation combination), to which the current computation combination may be changed when the combinations are changed in the designated order as described above. Without being limited thereto, the electronic device 101 may calculate the costs for some of the remaining plurality of computation combinations, except for the current computation combination. In this case, if the calculated costs are higher than a preset threshold, the electronic device 101 may maintain the currently selected computation combination (e.g., the first computation combination). According to an embodiment, the threshold may be set as a cost value associated with the currently selected computation combination (e.g., the first computation combination), but the disclosure is not limited thereto. If at least some of the calculated costs are lower than the preset threshold, the electronic device 101 may identify the lowest cost from at least some of the calculated costs, and change a present computation combination to the computation combination having the lowest cost as described above.

According to various embodiments, the electronic device 101 (e.g., the evaluation module 233) may calculate costs for at least some of the plurality of computation combinations, based on result data for some of the plurality of computation combinations, and energy consumption associated with some of the plurality of computation combinations and the computation combination having the highest step during a designated period. For example, the electronic device 101 may calculate the difference between the result data for some of the plurality of computation combinations and the result data for the computation combination having the highest step and calculate costs based on the calculated difference and energy (e.g., power) consumed while processing data (or content) using the quantized artificial intelligence model based on some of the plurality of computation combinations. As an example, the electronic device 101 may calculate costs as in Equation 1 below. Meanwhile, an equation for calculating costs may include more parameters in addition to the parameters of Equation 1. Thus, the calculated costs may indicate the difference between the result data for some of the plurality of computation combinations and the result data having the highest accuracy and energy consumption during data (or content) processing by some of the plurality of computation combinations. A smaller cost may indicate a smaller difference from the result data having the highest accuracy and smaller energy consumption.

Cost=Σ|Out_Candi(x,y)−Out_max(x,y)|+α·Energy_Candi [Equation 1]

In Equation 1, Out_candi denotes part of result data (e.g., (x,y) denotes one pixel, for image data, or a specific time frame for audio data) of some of a plurality of computation combinations for which costs are to be calculated, Out_max denotes part of result data (i.e., part of the best result data) of the computation combination having the highest step, Energy_candi denotes energy consumed when computation is performed by some of the plurality of computation combinations for which costs are to be calculated, and α denotes a constant.

For example, as illustrated in FIG. 9, the electronic device 101 (e.g., the evaluation module 233) may obtain quantized artificial intelligence models (e.g., 910 and 920) having the parameter (e.g., weight and activation function) based on some of the plurality of computation combinations, and the computation combination having the highest step during a designated period (e.g., an evaluation period). The computation of obtaining the quantized artificial intelligence models is performed by reconstructing and/or reimplementing parameters of a pre-trained artificial intelligence model as described above, and no duplicate description thereof is given. The electronic device 101 (e.g., the evaluation module 233) may control different processors (e.g., the first processor 221 and the second processor 223) to process data (or content) 901 during a designated period and obtain result data (e.g., first result data 911 and second result data 921) from each of the processors. Each of the processors processing the data (or content) 901 may be a processor corresponding to computation combinations as described above. Alternatively, without being limited thereto, one processor may process data (or content) using quantized artificial intelligence models (e.g., 910 and 920) based on some of the plurality of computation combinations, and the computation combination having the highest step. The electronic device 101 (e.g., the evaluation module 233) may calculate the difference between the respective corresponding parts (e.g., data of at least one pixel for image data, or data of at least one time frame for audio data) of the obtained result data (e.g., the first result data 911 and the second result data 921). As another example, the electronic device 101 (e.g., the evaluation module 233) may obtain information about the amount of energy (or the amount of resources, power, or computed data) consumed according to the processing operation by each processor while each processor (e.g., the first processor 221 and the second processor 223) processes obtained data (or content) during the designated period. As an example, the electronic device 101 (e.g., a processor) may monitor the amount of energy consumed during the processing operation by each processor. Resultantly, the electronic device 101 (e.g., the evaluation module 233) may calculate costs for some of the plurality of computation combinations based on the difference between the result data (e.g., the first result data 911 and the second result data 921) and the energy consumption and select the computation combination corresponding to the lowest cost among the calculated costs. Referring to state 1001 of FIG. 10, for specific image data, the difference in result data is large when the per-parameter type (e.g., weight and activation function) computation values differ (e.g., when computation combinations differ) but, for other image data, the difference in result data may be small when the per-parameter type computation values differ as shown in state 1002 of FIG. 10. The other image data may include a small amount of data to be processed according to the currently selected mode (e.g., the above-described object identification mode) as compared with the specific image data (e.g., the number of objects to be identified may be small). Thus, in the case where image data as shown in state 1002 of FIG. 10 is obtained, the difference in result data may be smaller, and energy consumption may be further reduced when the electronic device 101 selects a computation combination having a lower step as compared with when the electronic device 101 selects a computation combination having a higher step (that is, advantageous in terms of energy consumption). Thus, given what has been described above in connection with states 1001 and 1002 of FIG. 10, the electronic device 101 (e.g., the evaluation module 233) may calculate the costs indicating energy consumption upon data (or content) processing and the difference from the result data having the highest accuracy based on the occurrence of the designated event and select the computation combination having the lowest cost from among the calculated costs.

According to various embodiments, the electronic device 101 may perform the computations of processing data (or content) based on the plurality of computation combinations during a designated period (e.g., a result evaluation period) simultaneously or at different times. For example, as illustrated in FIG. 11A, the electronic device 101 may simultaneously perform the computation of processing data (or content) based on the plurality of computation combinations during a designated period (e.g., an evaluation period). The plurality of processors 220 corresponding to the plurality of computation combinations may process data (or content) using a quantized artificial intelligence model based on each of the plurality of computation combinations during the designated period. Alternatively, one processor may obtain result data by processing data (or content) using quantized artificial intelligence model based on the plurality of computation combinations during the designated period. As an example, referring to FIG. 11B, the electronic device 101 may sequentially perform the computations of processing data (or content) based on one of the plurality of computation combinations during the designated period (e.g., an evaluation period).

According to various embodiments, in operation 813, the electronic device 101 may obtain second result data (or content) by processing at least one data (or content) using a second deep learning model having at least one second parameter, obtained by configuring the at least one parameter of the deep learning model as at least one second parameter corresponding to the selected second values. For example, the electronic device 101 may process data (or content) obtained after a designated period, using the quantized artificial intelligence model based on the per-parameter type computation values of the selected combination (e.g., the second computation combination) after the designated period (e.g., an evaluation period). Operation 813 of the electronic device 101 may be performed like operation 511 of the electronic device 101 as described above, and no duplicate description thereof is given below for the sake of brevity.

According to various embodiments, there may be provided a method for operating an electronic device (e.g., the electronic device 101 of FIG. 1) including executing, by at least one processor of the electronic device (e.g., the electronic device 101 of FIG. 1), an application and obtaining at least one content based on the executed application, selecting first values from among a plurality of values associated with an computation capability to process the obtained at least one content, obtaining first result data by processing the at least one content, using a first artificial intelligence model having at least one first parameter, obtained by configuring at least one parameter of an artificial intelligence model (e.g., the artificial intelligence models 243 of FIG. 2) stored in the electronic device (e.g., the electronic device 101 of FIG. 1) as the at least one first parameter corresponding to the first values, selecting second values from among the plurality of values based on an occurrence of a specific event, and obtaining second result data by processing the at least one content, using a second artificial intelligence model having at least one second parameter, obtained by configuring the at least one parameter of the artificial intelligence model as the at least one second parameter corresponding to the second values.

According to various embodiments, there may be provided the method, in which the occurrence of the specific event includes at least one of a lapse of a specific time, identification of a change to a characteristic of the at least one content, or identification of a movement of the electronic device (e.g., the electronic device 101 of FIG. 1).

According to various embodiments, there may be provided the method, in which the artificial intelligence model is a model pre-trained to output result data in response to receiving the at least one data obtained based on execution of the application, and the at least one parameter of the artificial intelligence model includes at least one weight and at least one activation function obtained according to the training.

According to various embodiments, there may be provided the method, in which the plurality of values associated with the computation capability include combinations of values each including a value for the weight and a value for the activation function, and the value for the weight and the value for the activation function are associated with the computation capability.

According to various embodiments, there may be provided the method, further including, when an event for processing the at least one content obtained based on the executed application occurs, selecting a first combination including a first value for the weight and a first value for the activation function, as the first values, from among the combinations of the values and when the specific event occurs, selecting a second combination including a second value for the weight and a second value for the activation function, as the second values, from among the combinations of the values.

According to various embodiments, there may be provided the method, further including obtaining the first artificial intelligence model by setting the at least one weight of the artificial intelligence model as at least one first weight based on the first value for the weight and the at least one activation function of the artificial intelligence model as at least one first activation function based on the first value for the activation function and obtaining the second artificial intelligence model by setting the at least one weight of the artificial intelligence model as at least one second weight based on the second value for the weight and the at least one activation function of the artificial intelligence model as at least one second activation function based on the second value for the activation function.

According to various embodiments, there may be provided the method, further including identifying a first processor corresponding to the first value for the weight and the first value for the activation function among a plurality of processors of the electronic device (e.g., the electronic device 101 of FIG. 1) and controlling the first processor to process the at least one content using the first artificial intelligence model and identifying a second processor corresponding to the second value for the weight and the second value for the activation function among the plurality of processors of the electronic device (e.g., the electronic device 101 of FIG. 1) and controlling the second processor to process the at least one content using the second artificial intelligence model.

According to various embodiments, there may be provided the method, further including calculating costs for some of the combinations of the values based on a value for the weight and a value for the activation function corresponding to each of some of the combinations of the values during a specific period based on the occurrence of the specific event, the costs indicating an accuracy of result data obtained as the at least one data is processed based on some of the combinations of the values and energy consumption obtained as the at least one data is processed based on some of the combinations of the values and selecting a second combination of the values having a lowest cost among the calculated costs.

According to various embodiments, there may be provided the method, further including maintaining the processing of the at least one content using the first artificial intelligence model when the lowest cost among the calculated costs is a threshold or more.

According to various embodiments, there may be provided the method, further including identifying a third combination including a highest value for the weight and a highest value for the activation function among the combinations of the values, obtaining a third artificial intelligence model having at least one third parameter configured based on the highest value for the weight and the highest value for the activation function and obtaining artificial intelligence models having at least one fourth parameter configured based on values for the weight and values for the activation function corresponding to the some of the combinations of the values, obtaining third result data by processing the at least one data based on the third artificial intelligence model during the specific period and obtaining a plurality of result data by processing the at least one data based on the artificial intelligence models, and calculating a difference between at least, respective parts of the plurality of result data and at least part of the third result data.

According to various embodiments, there may be provided the method, further including obtaining information associated with an amount of energy consumed as the at least one data is processed based on each of the plurality of artificial intelligence models and calculating the costs based on the calculated difference and the consumed amount of energy.

According to various embodiments, there may be provided an electronic device (e.g., the electronic device 101 of FIG. 1), including at least one processor (e.g., the processor 230 of FIG. 2) configured to execute an application and obtaining at least one content based on the executed application, select first values from among a plurality of values associated with computation capability to process the obtained at least one content, obtain first result data by processing the at least one content, using a first artificial intelligence model having at least one first parameter, obtained by configuring at least one parameter of an artificial intelligence model (e.g., the artificial intelligence models 243 of FIG. 2) stored in the electronic device (e.g., the electronic device 101 of FIG. 1) as the at least one first parameter corresponding to the first values, select second values from among the plurality of values based on an occurrence of a specific event, and obtain second result data by processing the at least one content, using a second artificial intelligence model having at least one second parameter, obtained by configuring the at least one parameter of the artificial intelligence model as the at least one second parameter corresponding to the second values.

According to various embodiments, there may be provided the electronic device (e.g., the electronic device 101 of FIG. 1), in which the occurrence of the specific event includes at least one of a lapse of a specific time, identification of a change to a characteristic of the at least one content, or identification of a movement of the electronic device.

According to various embodiments, there may be provided the electronic device (e.g., the electronic device 101 of FIG. 1), in which the artificial intelligence model is a model pre-trained to output result data in response to receiving the at least one data obtained based on execution of the application, and the at least one parameter of the artificial intelligence model includes at least one weight and at least one activation function obtained according to the training.

According to various embodiments, there may be provided the electronic device (e.g., the electronic device 101 of FIG. 1), in which the plurality of values associated with the computation capability include combinations of values each including a value for the weight and a value for the activation function, and the value for the weight and the value for the activation function are associated with the computation capability.

According to various embodiments, there may be provided the electronic device (e.g., the electronic device 101 of FIG. 1), in which the at least one processor (e.g., the processor 230 of FIG. 2) is configured to, when an event for processing the at least one content obtained based on the executed application occurs, select a first combination including a first value for the weight and a first value for the activation function, as the first values, from among the combinations of the values, and when the designated event occurs, select a second combination including a second value for the weight and a second value for the activation function, as the second values, from among the combinations of the values.

According to various embodiments, there may be provided the electronic device (e.g., the electronic device 101 of FIG. 1), in which the at least one processor (e.g., the processor 230 of FIG. 2) is configured to obtain the first artificial intelligence model by setting the at least one weight of the artificial intelligence model as at least one first weight based on the first value for the weight and the at least one activation function of the artificial intelligence model as at least one first activation function based on the first value for the activation function and obtain the second artificial intelligence model by setting the at least one weight of the artificial intelligence model as at least one second weight based on the second value for the weight and the at least one activation function of the artificial intelligence model as at least one second activation function based on the second value for the activation function.

According to various embodiments, there may be provided the electronic device (e.g., the electronic device 101 of FIG. 1), in which the at least one processor (e.g., the processor 230 of FIG. 2) is configured to identify a first processor corresponding to the first value for the weight and the first value for the activation function among a plurality of processors of the electronic device and control the first processor to process the at least one content using the first artificial intelligence model and identify a second processor corresponding to the second value for the weight and the second value for the activation function among the plurality of processors of the electronic device and control the second processor to process the at least one content using the second artificial intelligence model.

According to various embodiments, there may be provided the electronic device (e.g., the electronic device 101 of FIG. 1), in which the at least one processor (e.g., the processor 230 of FIG. 2) is configured to calculate costs for some of the combinations of the values based on a value for the weight and a value for the activation function corresponding to each of some of the combinations of the values during a designated period based on the occurrence of the designated event, the costs indicating an accuracy of result data obtained as the at least one data is processed based on some of the combinations of the values and energy consumption obtained as the at least one data is processed based on some of the combinations of the values and select a second combination having a lowest cost among the calculated costs.

According to various embodiments, there may be provided a method for operating an electronic device (e.g., the electronic device 101 of FIG. 1), including executing an application and obtaining at least one content based on the executed application, selecting a first processor to process the obtained at least one content using an artificial intelligence model (e.g., the artificial intelligence models 243 of FIG. 2) stored in the electronic device (e.g., the electronic device 101 of FIG. 1), the first processor configured to correspond to first values among a plurality of values associated with computation capability, controlling the first processor to process the at least one content, using a first artificial intelligence model having at least one first parameter, obtained by configuring at least one parameter of an artificial intelligence model (e.g., the artificial intelligence models 243 of FIG. 2) stored in the electronic device (e.g., the electronic device 101 of FIG. 1) as the at least one first parameter corresponding to the first values, selecting a second processor based on an occurrence of a specific event, the second processor configured to correspond to second values among the plurality of values associated with the computation capability, and controlling the second processor to process the at least one content, using a second artificial intelligence model having at least one second parameter, obtained by configuring the at least one parameter of the artificial intelligence model as the at least one second parameter corresponding to the second values.

What is claimed is:

1. A method for operating an electronic device, the method comprising:
executing, by at least one processor of the electronic device, an application and obtaining at least one content based on the executed application;
selecting first values from among a plurality of values associated with an computation capability to process the obtained at least one content;
obtaining first result data by processing the at least one content, using a first artificial intelligence model having at least one first parameter, obtained by configuring at least one parameter of an artificial intelligence model stored in the electronic device as the at least one first parameter corresponding to the first values;
selecting second values from among the plurality of values based on an occurrence of a specific event; and
obtaining second result data by processing the at least one content, using a second artificial intelligence model having at least one second parameter, obtained by configuring the at least one parameter of the artificial intelligence model as the at least one second parameter corresponding to the second values.

2. The method of claim 1, wherein the occurrence of the specific event includes at least one of a lapse of a specific time, identification of a change to a characteristic of the at least one content, or an identification of a movement of the electronic device.

3. The method of claim 1, wherein the artificial intelligence model is a model pre-trained to output result data in response to receiving the at least one data obtained based on execution of the application, and wherein the at least one parameter of the artificial intelligence model includes at least one weight and at least one activation function obtained according to the training.

4. The method of claim 3, wherein the plurality of values associated with the computation capability include combinations of values each including a value for the weight and a value for the activation function, and wherein the value for the weight and the value for the activation function are associated with the computation capability.

5. The method of claim 4, further comprising:
when an event for processing the at least one content obtained based on the executed application occurs, selecting a first combination including a first value for the weight and a first value for the activation function, as the first values, from among the combinations of the values; and
when the specific event occurs, selecting a second combination including a second value for the weight and a second value for the activation function, as the second values, from among the combinations of the values.

6. The method of claim 5, further comprising:
obtaining the first artificial intelligence model by setting the at least one weight of the artificial intelligence model as at least one first weight based on the first value for the weight and the at least one activation function of the artificial intelligence model as at least one first activation function based on the first value for the activation function; and
obtaining the second artificial intelligence model by setting the at least one weight of the artificial intelligence model as at least one second weight based on the second value for the weight and the at least one activation function of the artificial intelligence model as at least one second activation function based on the second value for the activation function.

7. The method of claim 6, further comprising:
identifying a first processor corresponding to the first value for the weight and the first value for the activation function among a plurality of processors of the electronic device and controlling the first processor to process the at least one content using the first artificial intelligence model; and
identifying a second processor corresponding to the second value for the weight and the second value for the activation function among the plurality of processors of the electronic device and controlling the second processor to process the at least one content using the second artificial intelligence model.

8. The method of claim 5, further comprising:
calculating costs for some of the combinations of the values based on a value for the weight and a value for the activation function included in each of some of the combinations of the values during a specific period based on the occurrence of the specific event, the costs indicating an accuracy of result data obtained when the at least one data is processed based on some of the combinations of the values, and energy consumption obtained when the at least one data is processed based on some of the combinations of the values; and
selecting the second combination of the values having a lowest cost among the calculated costs.

9. The method of claim 8, further comprising maintaining the processing of the at least one content using the first artificial intelligence model when the lowest cost among the calculated costs is a threshold or more.

10. The method of claim 8, further comprising:
identifying a third combination including a highest value for the weight and a highest value for the activation function among the combinations of the values;
obtaining a third artificial intelligence model having at least one third parameter configured based on the highest value for the weight and the highest value for the activation function and obtaining artificial intelligence models having at least one fourth parameter configured based on values for the weight and values for the activation function included in the some of the combinations of the values;
obtaining third result data by processing the at least one data based on the third artificial intelligence model during the designated period, and obtaining a plurality of result data by processing the at least one data based on the artificial intelligence models; and
calculating a difference between at least, respective parts of the plurality of result data and at least part of the third result data.

11. The method of claim 10, further comprising:
obtaining information associated with an amount of energy consumed when the at least one data is processed based on each of the plurality of artificial intelligence models; and
calculating the costs based on the calculated difference and the consumed amount of energy.

12. An electronic device, comprising:
at least one processor configured to:
execute an application and obtaining at least one content based on the executed application;
select first values from among a plurality of values associated with an computation capability to process the obtained at least one content;
obtain first result data by processing the at least one content, using a first artificial intelligence model having at least one first parameter, obtained by configuring at least one parameter of an artificial intelligence model stored in the electronic device as the at least one first parameter corresponding to the first values;
select second values from among the plurality of values based on an occurrence of a specific event; and
obtain second result data by processing the at least one content, using a second artificial intelligence model having at least one second parameter, obtained by configuring the at least one parameter of the artificial intelligence model as the at least one second parameter corresponding to the second values.

13. The electronic device of claim 12, wherein the occurrence of the specific event includes at least one of a lapse of a specific time, identification of a change to a characteristic of the at least one data, or an identification of a movement of the electronic device.

14. The electronic device of claim 12, wherein the artificial intelligence model is a model pre-trained to output result data in response to receiving the at least one data obtained based on execution of the application, and wherein the at least one parameter of the artificial intelligence model includes at least one weight and at least one activation function obtained according to the training.

15. The electronic device of claim 14, wherein the plurality of values associated with the computation capability include combinations of values each including value for the weight and a value for the activation function, and wherein the value for the weight and the value for the activation function are associated with the computation capability.

16. The electronic device of claim 15, wherein the at least one processor is configured to:
when an event for processing the at least one content obtained based on the executed application occurs, select a first combination including a first value for the weight and a first value for the activation function, as the first values, from among the combinations of the values; and
when the specific event occurs, select a second combination including a second value for the weight and a second value for the activation function, as the second values, from among the combinations of the values.

17. The electronic device of claim 16, wherein the at least one processor is configured to:
obtain the first artificial intelligence model by setting the at least one weight of the artificial intelligence model as at least one first weight based on the first value for the weight and the at least one activation function of the artificial intelligence model as at least one first activation function based on the first value for the activation function; and
obtain the second artificial intelligence model by setting the at least one weight of the artificial intelligence model as at least one second weight based on the second value for the weight and the at least one activation function of the artificial intelligence model as at least one second activation function based on the second value for the activation function.

18. The electronic device of claim 17, wherein the at least one processor is configured to:
identify a first processor corresponding to the first value for the weight and the first value for the activation function among a plurality of processors of the electronic device and control the first processor to process the at least one content using the first artificial intelligence model; and
identify a second processor corresponding to the second value for the weight and the second value for the activation function among the plurality of processors of the electronic device and control the second processor to process the at least one content using the second artificial intelligence model.

19. The electronic device of claim 16, wherein the at least one processor is configured to:
calculate costs for some of the combinations of the values based on a value for the weight and a value for the activation function corresponding to each of some of the combinations of the values during a designated period based on the occurrence of the designated event, the costs indicating an accuracy of result data obtained as the at least one data is processed based on some of the combinations of the values and energy consumption obtained as the at least one data is processed based on some of the combinations of the values; and
select a second combination of the values having a lowest cost among the calculated costs.

20. A method for operating an electronic device, the method comprising:
executing, by at least one processor of the electronic device, an application and obtaining at least one content based on the executed application;
selecting a first processor to process the obtained at least one content using an artificial intelligence model stored in the electronic device, the first processor configured to correspond to first values among a plurality of values associated with an computation capability;
controlling the first processor to process the at least one content, using a first artificial intelligence model having at least one first parameter, obtained by configuring at least one parameter of an artificial intelligence model stored in the electronic device as the at least one first parameter corresponding to the first values;
selecting a second processor based on an occurrence of a specific event, the second processor configured to correspond to second values among the plurality of values associated with the computation capability; and
controlling the second processor to process the at least one content, using a second artificial intelligence model having at least one second parameter, obtained by configuring the at least one parameter of the artificial intelligence model as the at least one second parameter corresponding to the second values.
